(19) United States
(12) Patent Application Publication
(10) Pub. No.: US 2008/0163497 A1
(43) Pub. Date: Jul. 10, 2008

(54) Pole Saw Scabbard/Lanyard Combination for Tree Climbing

(75) Inventor: Douglas Norman Hartz, Chambersburg, PA (US)

Correspondence Address: Douglas N. Hartz, 450 Mower Road, Chambersburg, PA, 17201, US

(73) Assignee: Douglas Norman Hartz, Chambersburg, PA (US)

(21) Appl. No.: 11/735,970

(22) Filed: Jun. 19, 2007

Related U.S. Application Data
(60) Provisional application No. 60/883,843, filed on Jan. 8, 2007.

(51) Int. Cl. B26B 29/00

(52) U.S. Cl. 30/286

(57) ABSTRACT

An apparatus for safely covering the sharp blade of a pole saw while tree climbing is provided by combining a pole saw scabbard and a lanyard. The lanyard slides thru hardware mounted along the back, outside curve of the scabbard. A loop of the lanyard extends down from the lowest mounting hardware where the blade enters the scabbard, just far enough to be placed around the hook of a pole saw. The other end of the lanyard extends up from the highest mounting hardware at the tip of the scabbard, to be attached to the climbers belt or saddle. This safely suspends the now covered pole saw while climbing aloft in a tree.

### BACKGROUND

The purpose of the invention is to Provide an easy way to cover the sharp blade of a pole saw used for tree trimming, while in the tree. Many climbers have been severely cut by falling pole saws in trees. To my knowledge as a climber and a certified arborist I know of no easy way of storing a pole saw in a tree without being exposed to the blade. If its not simple and fast climbers won't use it.

### DESCRIPTION

The preferred embodiment of the pole saw scabbard and lanyard combination consist of: a 7 mm lanyard that slides/threads thru clamps mounted along the back of a typical pole saw scabbard. (See FIG. 2.) A loop on the lanyard extends just enough through the lowest clamp to be stretched around the hook of the pole saw. The other end of the lanyard has a snap attached to suspend the whole from a tree climbers belt. (See FIG. 1.)

To make this preferred embodiment: beginning with a typical pole saw scabbard attach 4 clamps along the outside curve of the scabbard. I attached these by sliding the tabs of the clamps between the leather/belt material layers of the scabbard, drilling corresponding holes thru these layers, and securing the clamps with bolts and lock nuts. The first three clamps beginning at the tip of the scabbard should be ⅜″ diameter to allow a 7 mm rope to slide through freely. The last clamp attached should be V₂″ diameter to allow a loop of a 7 mm rope to slide through freely. This last clamp should be placed about 1″ from the wide end of the scabbard. The lanyard should be made out of 7 mm Kernmantle rope with swaged ends. One end with an approximately 4″ loop to be placed around the hook of the pole saw, and one end looped tight around a snap.

### SUMMARY

I believe I have invented a quick easy and safe way to store this tool (pole saw). You slide the scabbard on the bade, put the loop around the hook, drop it, and it hangs there until you need it. Mounting a series of clamps up the back of the scabbard for the rope to run thru is unique. The 7 mm rope itself supports the weight of the actual pole saw by the hook. The rope exits at the tip of the scabbard reducing the possibility of snagging on branches. The leather/belt material scabbard bears no weight which will reduce wear and damage to the scabbard and reduce bending of the blade.

### DESCRIPTION OF DRAWINGS

FIG. 1 shows the pole saw scabbard/lanyard combination in use by a climber in a tree. The scabbard is shown covering the blade. The bottom end of the lanyard is shown looped around the hook of the pole saw. The upper end of the lanyard is shown attached to the climbers saddle safely suspending the pole saw.

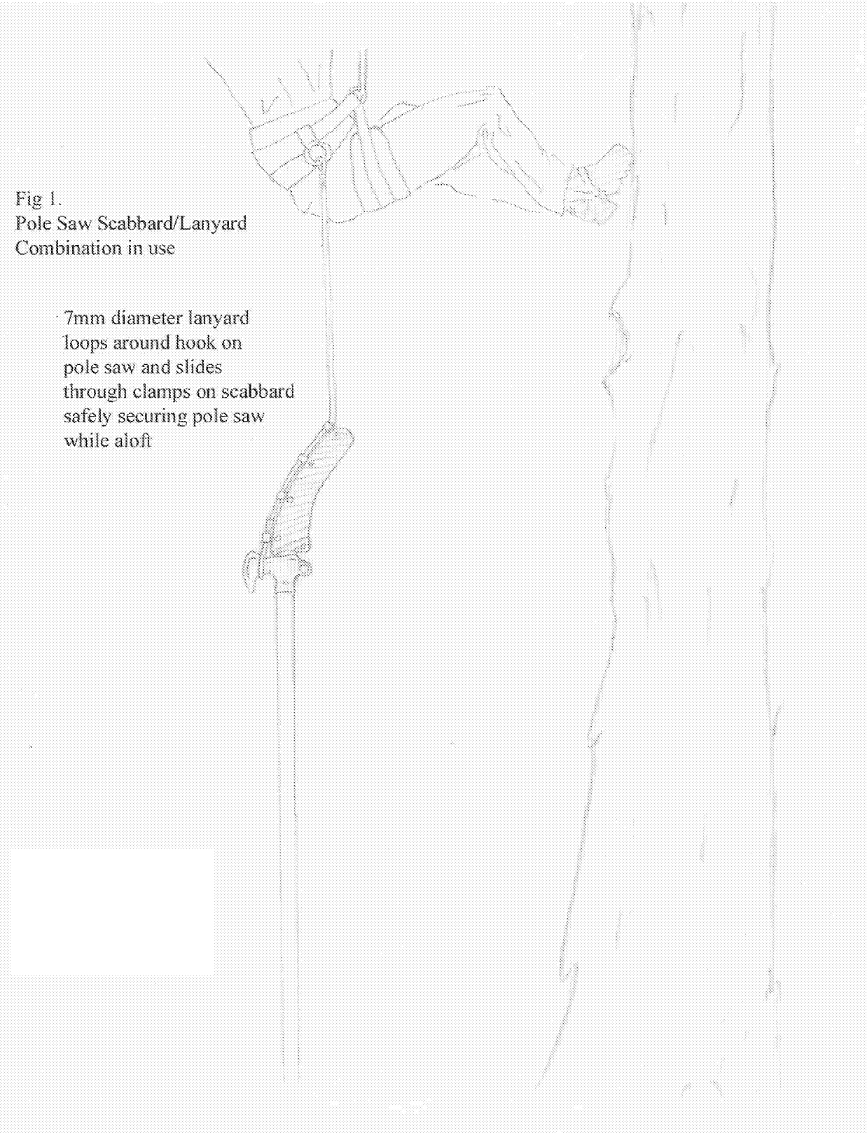

FIG. 2 shows a closer view of the scabbard/lanyard combination by itself. The lanyard is shown threaded thru the clamps mounted on the back of the scabbard. The upper three clamps are smaller than the lowest clamp. Aluminum sleeves used to create loops (swaged ends) on the lanyard can also be seen. One loop on the lanyard can be seen extending just enough thru the lowest clamp to be put around the hook of a pole saw.

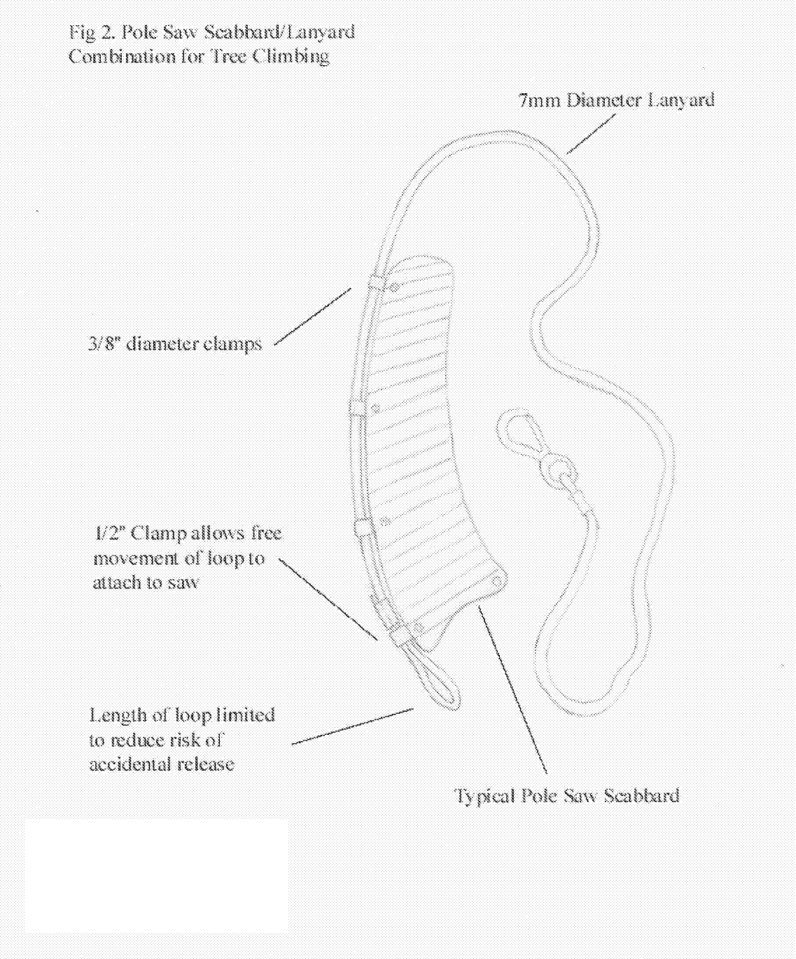

FIG. 3 shows the tools that were modified: a typical pole saw scabbard and a typical chainsaw lanyard, as well a an example of a pole saw used for tree trimming.

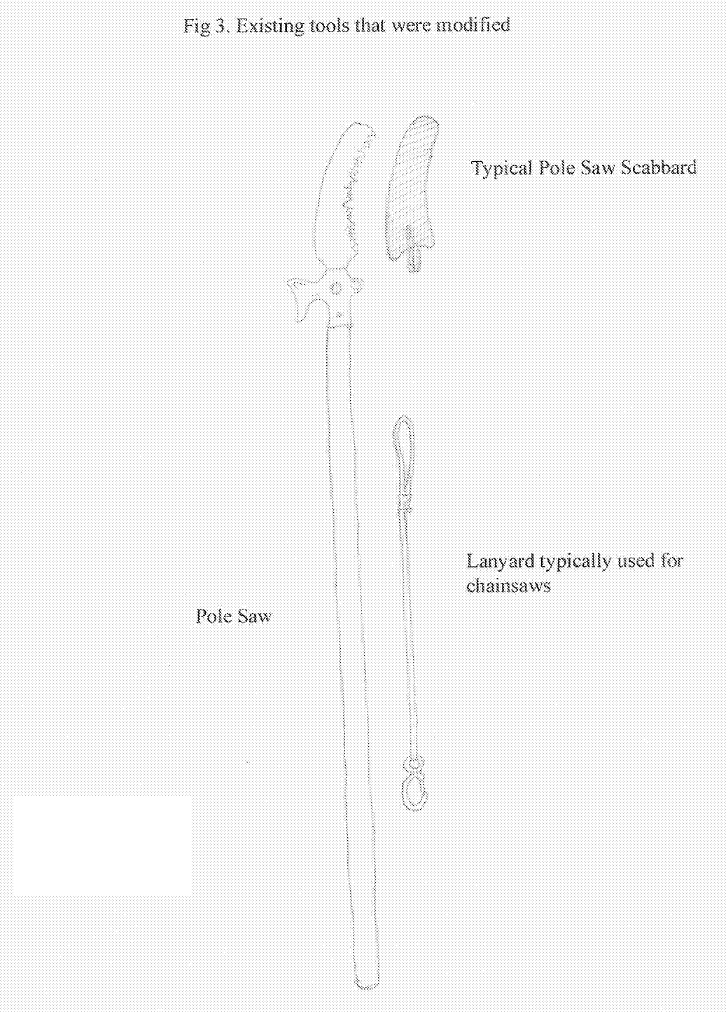

What is claimed is:

1. A combination lanyard and scabbard used for storing a pole saw while climbing aloft in a tree comprising:
(a) a lanyard comprised of rope or webbing that slides, travels, or is channeled along, or thru a scabbard, or other covering for a pole saws blade
(b) whereby the said scabbard, or other covering can be placed over the said blade, such that the blade is covered while the said lanyard is attached to the said pole saws hook at the one end, and a tree climbers belt, or saddle at the opposite end, safely storing a pole saw while climbing aloft in a tree.
